(19) United States
(12) Patent Application Publication
(10) Pub. No.: US 2012/0005282 A1
(43) Pub. Date: Jan. 5, 2012

(54) COLLABORATIVE RANKING AND FILTERING OF ELECTRONIC MAIL MESSAGES

(75) Inventors: Nicole D. Steinbok, Redmond, WA (US); Jonathan J. Cadiz, Bellevue, WA (US); John C. Platt, Bellevue, WA (US); F. David Jones, Bellevue, WA (US); David John Rasmussen, Redmond, WA (US); Thirumalesh K. Bhat, Sammamish, WA (US); Mark R. Dawson, Sammamish, WA (US); Eli Y. Tamanaha, Lynnwood, WA (US); Bill Li, District YangPu (CN); Brian D. Williams, Las Vegas, NV (US)

(73) Assignee: Microsoft Corporation, Redmond, WA (US)

(21) Appl. No.: 12/829,676

(22) Filed: Jul. 2, 2010

(51) Int. Cl. G06F 15/16

(52) U.S. Cl. 709/206

(57) ABSTRACT

Electronic mail messages may be collaboratively ranked and filtered. User actions on an electronic mail message received from a sender by one or more recipients may be monitored. Statistics may be generated based on the user actions. The generated statistics may be utilized to provide a quality ranking of the electronic mail message based on the generated statistics.

### COPYRIGHT NOTICE

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever.

### BACKGROUND

Large scale computer networks, such as corporate networks, may support the daily exchange of hundreds of electronic mail (“e-mail”) messages among thousands of recipients in large distribution lists. As a result, the recipients must often spend time sifting through hundreds of e-mail messages per day in order to decide whether to read, delete, or store a particular e-mail message. Furthermore, senders are often unaware of what the recipients did with an e-mail message (i.e., whether or not the message was read, forwarded, or deleted) or what the recipients thought of the content of the message (i.e., whether or not the recipients liked, agreed, disagreed, or disliked the message). It is with respect to these considerations and others that the various embodiments of the present invention have been made.

### SUMMARY

This summary is provided to introduce a selection of concepts in a simplified form that are further described below in the Detailed Description. This summary is not intended to identify key features or essential features of the claimed subject matter, nor is it intended as an aid in determining the scope of the claimed subject matter.

Embodiments are provided for the collaborative ranking and filtering of electronic mail messages. User actions on an electronic mail message received from a sender by one or more recipients may be monitored. Statistics may be generated based on the user actions. The generated statistics may be utilized to provide a quality ranking of the electronic mail message based on the generated statistics.

These and other features and advantages will be apparent from a reading of the following detailed description and a review of the associated drawings. It is to be understood that both the foregoing general description and the following detailed description are illustrative only and are not restrictive of the invention as claimed.

### BRIEF DESCRIPTION OF THE DRAWINGS

FIG. 1 is a block diagram illustrating a network architecture for collaborative ranking and filtering of electronic mail messages, in accordance with various embodiments;

FIG. 2 is a block diagram illustrating a computing environment for collaborative ranking and filtering of electronic mail messages, in accordance with various embodiments;

FIG. 3 is a block diagram illustrating contents of statistics generated by an application utilized in the collaborative ranking and filtering of electronic mail messages, in accordance with an embodiment; and

FIG. 4 is a flow diagram illustrating a routine for collaborative ranking and filtering of electronic mail messages, in accordance with various embodiments.

### DETAILED DESCRIPTION

Embodiments are provided for the collaborative ranking and filtering of electronic mail messages. User actions on an electronic mail message received from a sender by one or more recipients may be monitored. Statistics may be generated based on the user actions. The generated statistics may be utilized to provide a quality ranking of the electronic mail message based on the generated statistics.

In the following detailed description, references are made to the accompanying drawings that form a part hereof, and in which are shown by way of illustrations specific embodiments or examples. These embodiments may be combined, other embodiments may be utilized, and structural changes may be made without departing from the spirit or scope of the present invention. The following detailed description is therefore not to be taken in a limiting sense, and the scope of the present invention is defined by the appended claims and their equivalents.

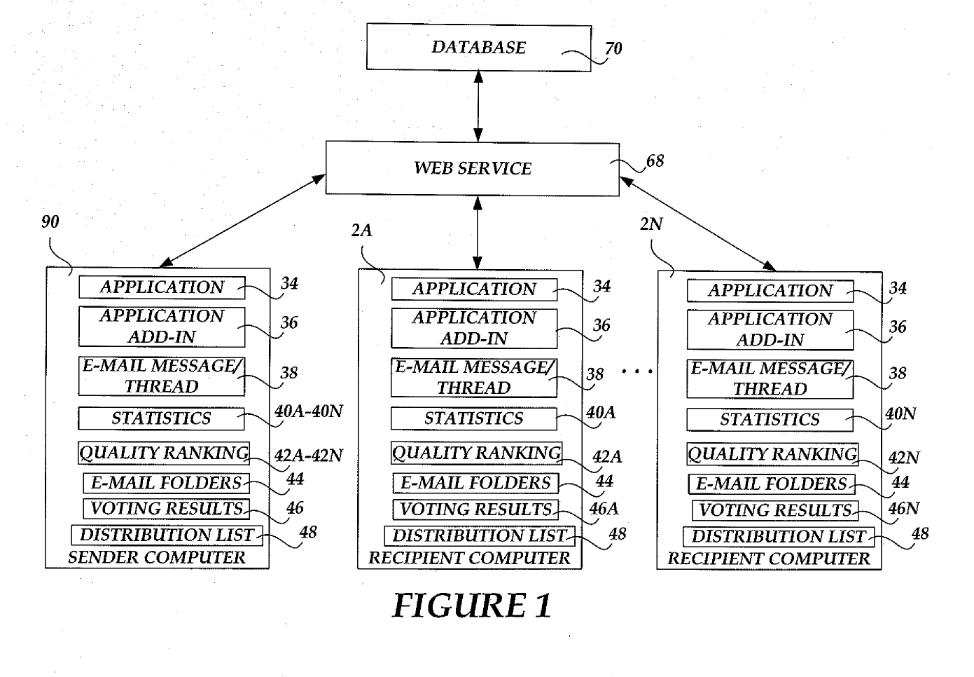

Referring now to the drawings, in which like numerals represent like elements through the several figures, various aspects of the present invention will be described. FIG. 1 is a block diagram illustrating a network architecture which may be utilized for collaborative ranking and filtering of electronic mail messages, in accordance with various embodiments. The network architecture includes a sender computer 90 and recipient computers 2A-2N which are in communication with a database 70 via a web server 68. In accordance with an embodiment, the sender computer 90 and the recipient computers 2A-2N may comprise numerous client or server computers utilized by related users in an electronic mail (“e-mail”) distribution list. It should be understood, however, that in accordance with other embodiments, the sender computer 90 and the recipient computers 2A-2N may comprise client or server computers which are individually utilized by unrelated users in the network architecture of FIG. 1. Moreover, the number of users may be as few as one or as many as a maximum number of users (e.g., several thousands) which may be supported by the web service 68 and the database 70 in a wide area computing network, such as the Internet. It should further be understood that, in accordance with various embodiments, the sender computer 90 may also function as a recipient computer (i.e., a recipient of sent e-mail) when a user of the sender computer sends an e-mail to himself or herself.

The sender computer 90 may comprise a client or server computer which includes an application 34, an (optional) application add-in 36, one or more e-mail messages or threads 38, statistics 40A-40N, quality rankings 42A-42N, e-mail folders 44, voting results 46, and a distribution list 48. It should be understood that, as defined herein, an electronic mail message thread may include multiple electronic mail messages. The application 34 may comprise an e-mail application for sending, receiving and managing the one or more e-mail messages or threads 38, as well as functionality for managing calendars and task lists, note and journal taking, and web browsing. In accordance with an embodiment, the application 34 may optionally comprise program code which is utilized for the collaborative ranking and filtering of electronic mail messages. In accordance with an alternative embodiment, the application add-in 36 may comprise a computer software program that extends the capabilities of the application 34 so that the application 34 may be utilized for the collaborative ranking and filtering of electronic mail messages.

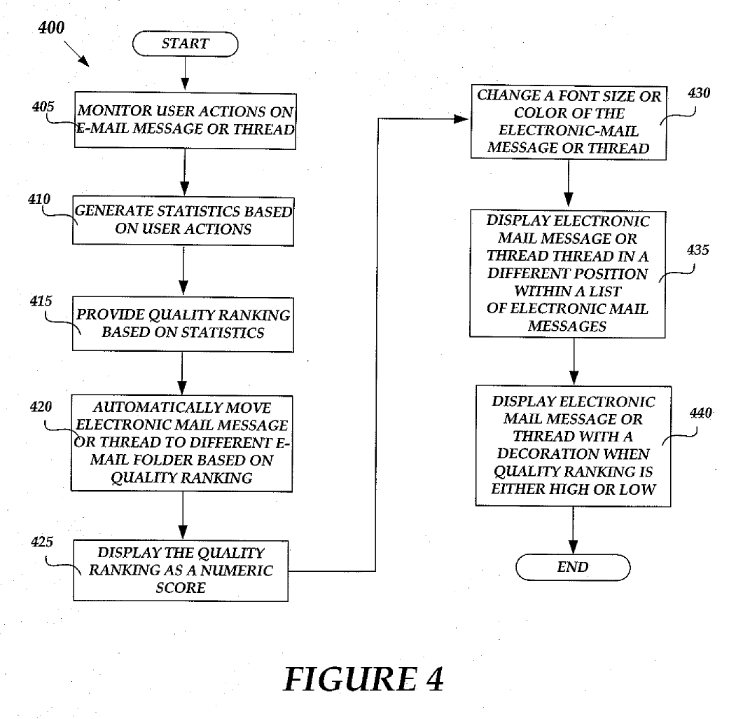

For example, on the sender computer 90, the application 34 may be configured to display feedback detailed in the statistics 40A-40N as well as the quality rankings 42A-42N and the voting results 46 received from the recipient computers 2A-2N for one or more sent e-mail messages or threads 38. In accordance with an embodiment, the application 34 may include a “voting” feature to request a tally of results (i.e., responses) to a multiple-choice question by a sender of an e-mail message or thread. As should be appreciated by those skilled in the art, the received feedback and quality rankings may be utilized by the sender to improve the quality of future e-mails sent to recipients who may optionally be in the distribution list 48. The aforementioned functionality of the application 34 as well as additional functionality will be described in greater detail below with respect to the recipient computers 2A-2N and in FIG. 4. It should be understood that, without departing from the spirit and scope of the various embodiments described herein, the application 34 (which may optionally be utilized in conjunction with the application add-in 36) may be operative to send a single e-mail message or thread 38 and receive statistics and quality rankings from a single recipient computer (i.e., the recipient computer 2A). The e-mail folders 44 may comprise various folders utilized by the application 34 for filtering one or more of the e-mail messages or threads 38. As a non-limiting example, the e-mail folders 44 may include an “inbox” folder for storing received new messages, a “sent” folder for storing sent messages, a “deleted” folder for storing deleted messages, a “spam” or “junk” folder for storing unsolicited or undesired e-mail messages, and one or more user-specified folders for storing e-mail messages which a user may have a particular interest in reading.

In accordance with an embodiment, the application 34 may comprise the OUTLOOK personal information manager from MICROSOFT CORPORATION from MICROSOFT CORPORATION of Redmond, Wash. Alternatively, the application 34 may comprise the EXCHANGE SERVER collaborative application product from MICROSOFT CORPORATION. In accordance another alternative embodiment, the application 34 may comprise a web browser application for accessing an e-mail web service such as the OUTLOOK WEB ACCESS (“OWA”) webmail service from MICROSOFT CORPORATION of Redmond, Wash. As is known to those skilled in the art, the OWA webmail service may be used to access e-mail, calendars, contacts, and other mailbox content when access to the OUTLOOK personal information manager is unavailable. It should be understood that the embodiments described herein should not be construed as being limited to the aforementioned software applications and that other software applications from other developers and/or manufacturers may also be utilized.

The recipient computers 2A-2N may comprise multiple client or server computers which include similar components as the sender computer 90, discussed above. For example, each of the recipient computers 2A-2N may include the application 34, the application add-in 36, one or more e-mail messages or threads 38, statistics (i.e., statistics 40A or 40N), quality rankings (i.e., quality rankings 42A or 42N), e-mail folders 44, voting results (i.e., voting results 46A-46N), and the distribution list 48. In accordance with various embodiments, the application 34 (alone, or optionally in conjunction with application add-in 36) on the recipient computers 2A-2N may be configured to monitor user actions (e.g., actions such as reading, deleting, forwarding, moving, etc.) on an e-mail message or thread 38 received from the sender computer 90. The application 34 may further be configured to generate statistics (e.g., the statistics 40A-40N) based on the user actions. The application 34 may further be configured to provide quality rankings (e.g., the quality rankings 42A-42N) for the e-mail message or thread 38 based on the generated statistics. The application 34 may further be configured to automatically move the e-mail message or thread 38 to a different e-mail folder based on quality ranking. The aforementioned functionality of the application 34 will be described in greater detail below with respect to FIG. 4.

The web service 68 may comprise a generic web service which is operative to communicate with the sender computer 90, the recipient computers 2A-2N and the database 70. In particular, the web service 68 may be utilized to receive the statistics 40A-40N and the quality rankings 42A-42N from the recipient computers 2A-2N and send them to the database 70 for aggregation. For example, the database 70 may be configured to collect, aggregate and store the statistics 40A-40N and the quality rankings 42A-42N received from the recipient computers 2A-2N. In accordance with an embodiment, the database 70 may further be configured to generate a summary e-mail which may be sent to the sender computer 90 via the web service 68. The summary e-mail may be utilized by a user of the sender computer 90 to receive feedback from the recipients of e-mails sent to the recipient computers 2A-2N and to improve the quality of future sent e-mails. In accordance with various embodiments, the database 70 may comprise a server which includes a number of features including, but not limited to, e-mail, calendaring, contacts and tasks, support for mobile and web-based access to information and support for data storage. It should be appreciated by those skilled in the art, that by providing the web service 68 as an additional layer between the computers 90 and 2A-2N, and the database 70, additional actions may be performed (such as batching and diagnosis) which would not be possible if the aforementioned client or server computers were connected directly to the database 70. Furthermore, by utilizing the web service 68 (which handles only HTTP traffic), issues with communicating through firewalls configured on various client or server computers may be avoided.

In accordance with an embodiment, the web service 68 and the database 70 may comprise the EXCHANGE SERVER collaborative application product from MICROSOFT CORPORATION of Redmond, Wash. It should be understood that the embodiments described herein should not be construed as being limited to the aforementioned software application and that other software applications from other developers and/or manufacturers may also be utilized.

### Exemplary Operating Environment

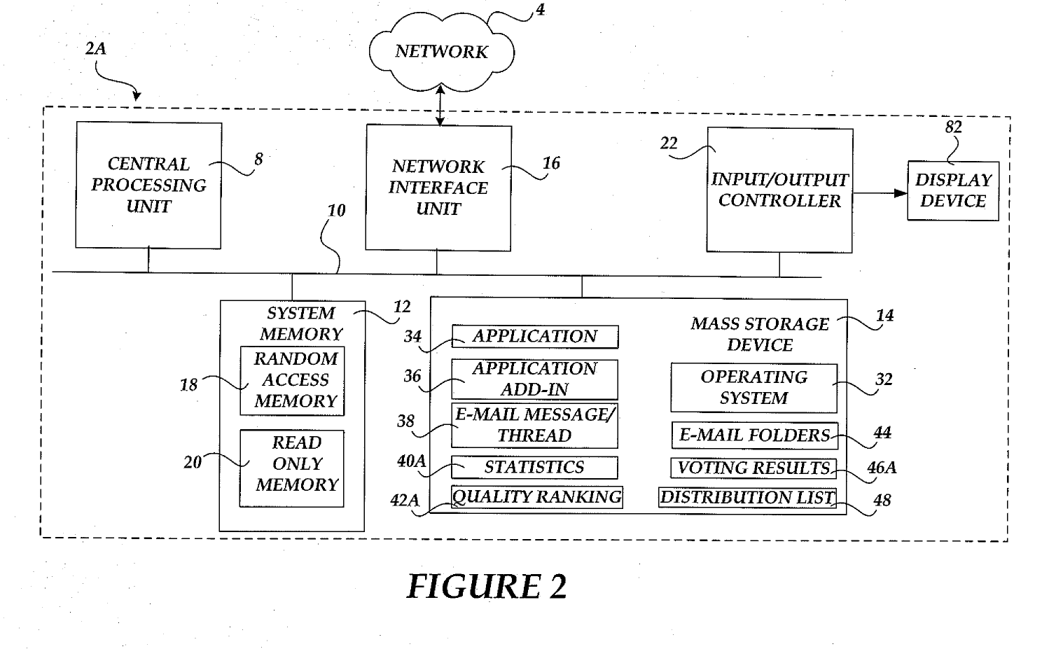

Referring now to FIG. 2, the following discussion is intended to provide a brief, general description of a suitable computing environment in which various illustrative embodiments may be implemented. While various embodiments will be described in the general context of program modules that execute in conjunction with program modules that run on an operating system on a computer, those skilled in the art will recognize that the various embodiments may also be implemented in combination with other types of computer systems and program modules.

Generally, program modules include routines, programs, components, data structures, and other types of structures that perform particular tasks or implement particular abstract data types. Moreover, those skilled in the art will appreciate that the various embodiments may be practiced with a number of computer system configurations, including hand-held devices, multiprocessor systems, microprocessor-based or programmable consumer electronics, minicomputers, mainframe computers, and the like. The various embodiments may also be practiced in distributed computing environments where tasks are performed by remote processing devices that are linked through a communications network. In a distributed computing environment, program modules may be located in both local and remote memory storage devices.

FIG. 2 shows the recipient computer 2A which may comprise any type of computer capable of executing one or more application programs. The recipient computer 2A includes at least one central processing unit 8 (“CPU”), a system memory 12, including a random access memory 18 (“RAM”) and a read-only memory (“ROM”) 20, and a system bus 10 that couples the memory to the CPU 8. A basic input/output system containing the basic routines that help to transfer information between elements within the computer, such as during startup, is stored in the ROM 20.

The recipient computer 2A may further include a mass storage device 14 for storing an operating system 32, the application 34, the application add-in 36, the e-mail message or thread 38, the statistics 40A, the quality rankings 42A, the e-mail folders 44, the voting results 46A, and the distribution list 48. In accordance with various embodiments, the operating system 32 may be suitable for controlling the operation of a networked computer, such as the WINDOWS operating systems from MICROSOFT CORPORATION of Redmond, Wash. The mass storage device 14 is connected to the CPU 8 through a mass storage controller (not shown) connected to the bus 10. The mass storage device 14 and its associated computer-readable media provide non-volatile storage for the recipient computer 2A. Although the description of computer-readable media contained herein refers to a mass storage device, such as a hard disk or CD-ROM drive, it should be appreciated by those skilled in the art that computer-readable media can be any available media that can be accessed or utilized by the recipient computer 2A. By way of example, and not limitation, computer-readable media may comprise computer storage media and communication media.

Computer storage media includes volatile and non-volatile, removable and non-removable hardware storage media implemented in any physical method or technology for the storage of information such as computer-readable instructions, data structures, program modules or other data. Computer storage media includes, but is not limited to, RAM, ROM, EPROM, EEPROM, flash memory or other solid state memory technology, CD-ROM, digital versatile disks (“DVD”), or other optical storage, magnetic cassettes, magnetic tape, magnetic disk storage or other magnetic storage devices, which can be used to store the desired information and which can be accessed by the recipient computer 2A.

Communication media includes any information delivery media. For example, in accordance with an embodiment, communication media may include a wired network or direct-wired connection. In accordance with another embodiment, communication media may include wireless media such as acoustic, RF, infrared, and other wireless media. In accordance with yet another embodiment, communication media may include computer-readable instructions, data structures, program modules or other data in a modulated data signal such as a carrier wave or other transport mechanism. The term “modulated data signal” means a signal that has one or more of its characteristics set or changed in such a manner as to encode information in the signal. Combinations of any of the above should also be included within the scope of computer-readable media. Computer-readable media may also be referred to as a computer program product.

According to various embodiments, the recipient computer 2A may operate in a networked environment using logical connections to remote computers through a network 4 which may comprise, for example, a local network or a wide area network (e.g., the Internet). The recipient computer 2A may connect to the network 4 through a network interface unit 16 connected to the bus 10. It should be appreciated that the network interface unit 16 may also be utilized to connect to other types of networks and remote computing systems. The recipient computer 2A may also include an input/output controller 22 for receiving and processing input from a number of input types, including a keyboard, mouse, pen, stylus, finger, voice input, and/or other means. Similarly, an input/output controller 22 may provide output to a display device 82, a printer, or other type of output device. Additionally, a touch screen can serve as an input and an output mechanism. It should be appreciated that the sender computer 90 and the recipient computer 2N (shown in FIG. 1) may include many of the conventional components shown and discussed above with respect to the recipient computer 2A.

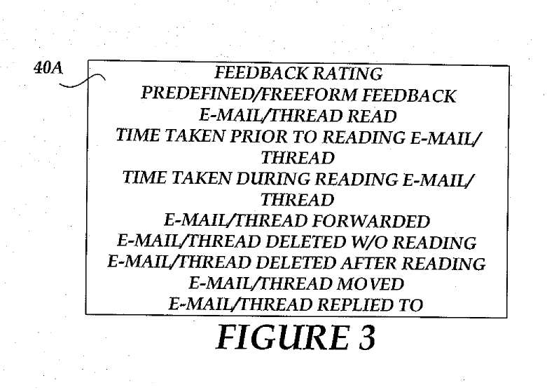

FIG. 3 is a block diagram illustrating statistics which may be generated by the application 34 on the recipient computers 2A-2N, in accordance with an embodiment. For example, the statistics 40A generated by the application 34 on the recipient computer 2A may include, without limitation, the following user actions which may be performed on the e-mail message or thread 38:

Feedback rating

Predetermined/Freeform feedback

E-mail/thread read

Time taken prior to reading e-mail/thread

Time taken during reading e-mail/thread

E-mail/thread forwarded

E-mail/thread deleted without reading

E-mail/thread deleted after reading

E-mail/thread moved

E-mail/thread replied to

As will be discussed in greater detail below with respect to FIG. 4, the statistics generated by the application 34 may be utilized as a basis to provide a quality ranking for an e-mail message or thread.

FIG. 4 is a flow diagram illustrating a routine 400 for collaborative ranking and filtering of electronic mail messages, in accordance with various embodiments. When reading the discussion of the routines presented herein, it should be appreciated that the logical operations of various embodiments of the present invention are implemented (1) as a sequence of computer implemented acts or program modules running on a computing system and/or (2) as interconnected machine logical circuits or circuit modules within the computing system. The implementation is a matter of choice dependent on the performance requirements of the computing system implementing the invention. Accordingly, the logical operations illustrated in FIG. 4 and making up the various embodiments described herein are referred to variously as operations, structural devices, acts or modules. It will be recognized by one skilled in the art that these operations, structural devices, acts and modules may be implemented in software, in firmware, in special purpose digital logical, and any combination thereof without deviating from the spirit and scope of the present invention as recited within the claims set forth herein.

The routine 400 begins at operation 405, where the application 34, executing on one or more of the recipient computers 2A-2N, monitors user actions on the e-mail message or thread 38 received from the sender computer 90. It will be appreciated that the user actions which are monitored may comprise the list of actions in the statistics 40A discussed above with respect to FIG. 3 or, alternatively any other user action which may be performed on an e-mail message or thread, as should be appreciated by those skilled in the art. For example, the application 34 may be configured to monitor whether a positive or negative feedback rating is received which represents an opinion of the quality of the e-mail message or thread 38 by users of one or more of the recipient computers 2A-2N. In particular, the application 34 may be configured to utilize a gesture-based rating system so that a user may select (e.g., via a user interface) a “thumbs up” or “thumbs down” button in order to opine as to the quality of a received e-mail message or thread. In accordance with another embodiment, the application 34 may be configured to enable a user to utilize and select (e.g., via a user interface) a “star” in a star-based rating system (e.g., five stars is indicative of a high quality e-mail while one star is indicative of a low quality e-mail). It should be appreciated that other types of rating systems which are known to those skilled in the art may also be utilized without departing from the scope of the embodiments discussed herein. The application 34 may further be configured to enable a user to select from a number of pre-canned responses associated with a selected feedback rating. For example, pre-canned responses for a negative feedback rating may include responses such as “Too long,” “Too complex,” “Not respectful,” “Main points not clear,” and “Not enough high value content.” The application 34 may further be configured to enable a user on one or more of the recipient computers 2A-2N to enter freeform feedback (i.e., text) in order to opine as to the quality of a received e-mail or thread. The application 34 may further be configured to determine whether or not the e-mail message or thread 38 was read by users of one or more of the recipient computers 2A-2N. The application 34 may further be configured to determine (if the e-mail message 38 or thread was read) how long it to a user to read the e-mail message or thread 38 (i.e., a time length prior to when the e-mail message 38 was read) and/or how much time did a user spend reading the e-mail message or thread 38 (i.e., a time length taken by a user while reading the e-mail message 38). The application 34 may further be configured to determine whether the e-mail message or thread 38 was deleted prior to being read by a user, whether or not a reply was sent to the e-mail message or thread 38, whether the e-mail message or thread 38 was forwarded to another user, and whether the e-mail message or thread 38 was moved from a receiving message folder to another folder among the e-mail folders 44. The application 34 may further be configured to monitor the voting results on each of the recipient computers 46A-46N by receiving a voting result from a recipient computer based on a question contained within the e-mail message or thread 38. It should be appreciated that in accordance with an embodiment, the application 34 may be configured to display the voting results of other recipient computers, in real-time when the e-mail message or thread 38 is being viewed on a particular recipient computer. Furthermore, in accordance with an embodiment, the application 34 may also be configured to send a new electronic mail message to the sender computer 90 with combined voting results from the recipients of the e-mail message or thread 38 upon the occurrence of one or more of the following: after all of the recipients have voted, after a (predetermined) percentage of the recipients have voted, and within a specific time frame relative to the sending of the e-mail message or thread 38 from the sender computer 90.

From operation 405, the routine 400 continues to operation 410 where the application 34, executing on one or more of the recipient computers 2A-2N, generates statistics based on one or more of the monitored user actions on the e-mail message or thread 38. For example, the application 34 may be configured to generate the statistics 40A discussed above with respect to FIG. 3. In accordance with an embodiment, the statistics generated by the application 34 may be anonymous (i.e., the user is not identified when the statistics are sent to the sender for review). In accordance with an alternative embodiment, the statistics generated by the application 34 may include an identification of the user (upon whose actions the statistics are based) when the statistics are sent to the sender for review.

From operation 410, the routine 400 continues to operation 415 where the application 34, executing on one or more of the recipient computers 2A-2N, provides a quality ranking of the e-mail message or thread 38 based on the statistics generated at operation 410. In accordance with an embodiment, the quality ranking may represent a numerical value (i.e., a “peer rank”) of an e-mail message or thread. It should be understood, that in accordance with various embodiments, the quality ranking for a thread may be determined from: (1) an average of various quality rankings determined for each of the e-mail messages in the thread; (2) the lowest or minimum quality ranking for an e-mail message in the thread; or (3) the highest or maximum quality ranking for an e-mail message in the thread. Thus, it may be appreciated that the more valuable e-mail messages have higher numerical values than other e-mail messages or threads sent by the sender. The quality ranking may also be indicative of a public reputation of the sender of the e-mail message or thread 38 among users of the recipient computers 2A-2N. In accordance with an embodiment, the public reputation of the sender may be used as a current or default quality ranking for any e-mail message or thread sent by the sender. Thus, in providing the quality ranking of the e-mail message or thread 38, the application 34 may update a current or default quality ranking associated with the sender higher or lower based on the statistics generated from the user actions of recipients. For example, an e-mail message or thread that was read for five minutes (e.g., the e-mail message or thread was opened for reading for five minutes in the application 34) by a recipient within the first three minutes of receipt and further received a positive feedback rating would cause the default quality ranking to increase while, conversely, an e-mail message or thread that was delivered to a recipient but deleted without being read (e.g., the e-mail message or thread was not opened for reading in the application 34) would cause the default quality ranking to decrease or remain the same (if the default quality ranking already had a minimum value). It should also be appreciated that a high or low quality ranking may also be utilized by recipients as a suggestion as to what to do with a received e-mail message or thread (i.e., either read or delete). It should be understood, in accordance with an embodiment, that the quality ranking of a sent e-mail message or thread may be continuously updated as the e-mail message or thread is communicated among multiple recipients. For example, based on user actions associated with a first recipient, the application 34 may increase a default quality ranking for an e-mail message or thread but when the e-mail message or thread is sent to subsequent recipients by the sender (or forwarded to the second recipient by the first recipient), the application 34 may either further decrease the current quality ranking provided as a result of the first recipient or alternatively decrease the current quality ranking, based on user actions associated with the subsequent recipients of the e-mail message or thread. It should further be understood that for an e-mail thread, in accordance with an embodiment, the thread may only be displayed to the recipients if the quality ranking for the thread is above a predetermined threshold level. Moreover, in accordance with an embodiment, when the quality ranking for the thread is above the aforementioned predetermined threshold level, only the best one or two e-mail messages in the thread (as may be determined from individual quality rankings) will be displayed.

From operation 415, the routine 400 continues to operation 420 where the application 34, executing on one or more of the recipient computers 2A-2N, may automatically move the e-mail message or thread 38 to a different e-mail folder based on a current quality ranking. Thus, the application 34 may be utilized to filter e-mail messages or threads based on the quality ranking. For example, if the e-mail message or thread 38 received by one or more of the recipient computers 2A-2N has a high quality ranking, then the application 34 may be configured to automatically move the e-mail message or thread 38 from an “inbox” folder to a user-specified folder utilized for storing messages which a user may have a particular interest in reading. Conversely, if the e-mail message or thread 38 received by one or more of the recipient computers 2A-2N has a low quality ranking, then the application 34 may be configured to automatically move the e-mail message or thread 38 from an inbox folder to a deleted folder (i.e., thereby deleting the e-mail) or to a “spam” or “junk” folder utilized for storing unsolicited or undesired e-mail messages or threads.

From operation 420, the routine 400 continues to operation 425 where the application 34, executing on one or more of the recipient computers 2A-2N, may display the current quality ranking as a numeric score (or value) for the e-mail message or thread 38.

From operation 425, the routine 400 continues to operation 430 where the application 34, executing on one or more of the recipient computers 2A-2N, may change the font size or color of the e-mail message or thread 38 based on the current quality ranking.

From operation 430, the routine 400 continues to operation 435 where the application 34, executing on one or more of the recipient computers 2A-2N, may display the e-mail message or thread 38 in a different position within a displayed list of e-mail messages.

From operation 435, the routine 400 continues to operation 440 where the application 34, executing on one or more of the recipient computers 2A-2N, may display the e-mail message or thread 38 with a decoration when the current quality ranking is either high or low in order to distinguish the e-mail message or thread 38 from other messages. From operation 440, the routine 400 then ends.

It should be understood, in accordance with an embodiment, that the application 34 may further be configured to send the statistics 40A-40N and the quality rankings 42A-42N, from the recipient computers 2A-2N, to the database 70. The database 70 may be configured to aggregate the statistics 40A-40N and the quality rankings 42A-42N in a summary e-mail message which is then periodically delivered (e.g., weekly) from the database 70 to the sender computer 90 for review. For example, the summary e-mail message delivered to the sender may indicate that an e-mail message that was sent to one hundred people was read by twenty recipients and deleted without having been read by eighty recipients. In accordance with another embodiment, the application 34 may be configured to send the statistics 40A-40N and the quality rankings 42A-42N, from the recipient computers 2A-2N, to the database 70. The database 70 may be configured to aggregate the statistics 40A-40N and the quality rankings 42A-42N as data and then send the aggregated data to the sender computer 90 for display by the application 34 on the sender computer 90 for review.

Although the invention has been described in connection with various illustrative embodiments, those of ordinary skill in the art will understand that many modifications can be made thereto within the scope of the claims that follow. Accordingly, it is not intended that the scope of the invention in any way be limited by the above description, but instead be determined entirely by reference to the claims that follow.

What is claimed is:

1. A computer-implemented method of collaborative ranking and filtering of electronic mail messages, comprising:
monitoring, by at least one computer, at least one user action on an electronic mail message from a sender to at least one recipient;
generating, by the at least one computer, a plurality of statistics based on the at least one user action; and
providing, by the at least one computer, a quality ranking of the electronic mail message based on the plurality of statistics.

2. The method of claim 1, wherein monitoring, by at least one computer, at least one user action on an electronic mail message from a sender to at least one recipient comprises receiving a feedback rating representing an opinion of a quality of the electronic mail message from the at least one recipient.

3. The method of claim 2, wherein receiving a feedback rating representing an opinion of a quality of the electronic mail message from the at least one recipient further comprises receiving at least one of predefined feedback and freeform feedback based on the feedback rating.

4. The method of claim 1, wherein monitoring, by at least one computer, at least one user action on an electronic mail message from a sender to at least one recipient further comprises receiving, from the at least one recipient, a voting result based on a question within the electronic mail message, wherein the voting result and other voting results from at least one other recipient are displayed to the at least one recipient in real-time and wherein a new electronic mail message with combined voting results is sent upon the occurrence of at least one of the following: after all of a plurality of recipients receiving the electronic mail message have voted, after a percentage of the plurality of recipients have voted, and within a specific time frame relative to the sending of the electronic mail message by the sender.

5. The method of claim 1, wherein monitoring, by at least one computer, at least one user action on an electronic mail message from a sender to at least one recipient comprises determining that the electronic mail message was read by the at least one recipient.

6. The method of claim 5, wherein determining that the electronic mail message was read by the at least one recipient comprises determining at least one of: a time length prior to when the electronic mail message was read by the at least one recipient and a time length taken by the at least one recipient while reading the electronic mail message.

7. The method of claim 1, wherein monitoring, by at least one computer, at least one user action on an electronic mail message from a sender to at least one recipient comprises determining that the electronic mail message was deleted prior to being read by the at least one recipient.

8. The method of claim 1, wherein monitoring, by at least one computer, at least one user action on an electronic mail message from a sender to at least one recipient comprises determining that a reply to the electronic mail message was sent by the at least one recipient.

9. The method of claim 1, wherein monitoring, by at least one computer, at least one user action on an electronic mail message from a sender to at least one recipient comprises determining that the electronic mail message was forwarded by the at least one recipient.

10. The method of claim 1, wherein monitoring, by at least one computer, at least one user action on an electronic mail message from a sender to at least one recipient comprises determining that the electronic mail message was moved from a receiving message folder by the at least one recipient.

11. The method of claim 1, wherein generating, by the at least one computer, a plurality of statistics based on the at least one user action comprises generating at least one of a plurality of statistics from at least one anonymous user.

12. The method of claim 1, wherein providing, by the at least one computer, a quality ranking of the electronic mail message based on the plurality of statistics comprises updating a current quality ranking associated with the sender based on the plurality of statistics, wherein the current quality ranking is based on a public reputation of the sender.

13. The method of claim 12, further comprising at least one of the following:
automatically moving the electronic mail message from a receiving message folder on the at least one computer to another location based on the current quality ranking;
displaying the current quality ranking as a numeric score;
changing at least one of a font size and a color of the electronic mail message;
displaying the electronic mail message in a different position within a list comprising a plurality of electronic mail messages; and
displaying the electronic mail message with a decoration when the current quality ranking is at least one of a high ranking and a low ranking.

14. A computer system for collaborative ranking and filtering of electronic mail messages in a thread, comprising:
a memory for storing executable program code; and
a processor, the processor functionally coupled to the memory and responsive to computer-executable instructions contained in the program code, wherein the processor is operative to:
monitor at least one user action on an electronic mail message thread from a sender to at least one recipient;
generate a plurality of statistics based on the at least one user action;
provide a quality ranking of the electronic mail message thread based on the plurality of statistics;
automatically moving the electronic mail message thread from a receiving message folder to another location based on the quality ranking;
display the quality ranking as a numeric score;
change at least one of a font size and a color of the electronic mail message thread;
display the electronic mail message thread in a different position within a list comprising a plurality of electronic mail message threads; and
display the electronic mail message thread with a decoration when the quality ranking is at least one of a high ranking and a low ranking.

15. The computer system of claim 14, wherein the processor, in monitoring at least one user action on an electronic mail message thread from a sender to at least one recipient, is further operative to receive a feedback rating representing an opinion of a quality of the electronic mail message thread from the at least one recipient, the feedback rating comprising at least one of predefined feedback and freeform feedback based on the feedback rating.

16. The computer system of claim 14, wherein the processor, in monitoring at least one user action on an electronic mail message thread from a sender to at least one recipient, is further operative to determine that the electronic mail message thread was read by the at least one recipient and to determine at least one of: a time length prior to when the electronic mail message thread was read by the at least one recipient and a time length taken by the at least one recipient while reading the electronic mail message thread.

17. The computer system of claim 14, wherein the processor, monitoring at least one user action on an electronic mail message thread from a sender to at least one recipient, is further operative to determine that the electronic mail message thread was at least one of: deleted prior to being read by the at least one recipient, replied to by the at least one recipient, forwarded by the at least one recipient and moved from a receiving message folder by the at least one recipient.

18. The computer system of claim 14, wherein the processor, in generating, a plurality of statistics based on the at least one user action comprises, is further operative to generate at least one of a plurality of statistics from at least one identified user.

19. The computer system of claim 14, wherein the processor, in providing a quality ranking of the electronic mail message thread based on the plurality of statistics, is further operative to update a current quality ranking associated with the sender based on the plurality of statistics, wherein the current quality ranking is based on a public reputation of the sender.

20. A computer-readable storage medium comprising computer-executable instructions which, when executed by a computer, will cause the computer to perform a method of collaborative ranking and filtering of electronic mail messages, comprising:
monitoring, by at least one computer, a plurality of user actions on an electronic mail message from a sender to a plurality of recipients in a distribution list, wherein monitoring the plurality of user actions comprises:
receiving a feedback rating representing an opinion of a quality of the electronic mail message from each of the plurality of recipients in the distribution list;
determining, for each of the plurality of recipients in the distribution list, whether the electronic mail message was read;
determining, for each of the plurality of recipients in the distribution list, whether the electronic mail message was deleted prior to being read;
determining, for each of the plurality of recipients in the distribution list, whether a reply was sent to the electronic mail message;
determining, for each of the plurality of recipients in the distribution list, whether the electronic mail message was forwarded; and
determining, for each of the plurality of recipients in the distribution list, whether the electronic mail message was moved from a receiving message folder;
generating, by the at least one computer, a plurality of statistics based on the plurality of user actions;
updating a current quality ranking associated with the sender based on the plurality of statistics, wherein the current quality ranking is based on a public reputation of the sender;
automatically moving the electronic mail message from the receiving message folder on the at least one computer to another location for facilitating reading by at least one recipient in the plurality of recipients in the distribution list, when the current quality ranking is high;
automatically deleting the electronic mail message from a receiving message folder on the at least one computer when the current quality ranking is low;
automatically moving the electronic mail message from a receiving message folder on the at least one computer to another location based on the current quality ranking;
displaying the current quality ranking as a numeric score;
changing at least one of a font size and a color of the electronic mail message;
displaying the electronic mail message in a different position within a list comprising a plurality of electronic mail messages; and
displaying the electronic mail message with a decoration when the current quality ranking is at least one of a high ranking and a low ranking.
